(19) United States
(12) Patent Application Publication
(10) Pub. No.: US 2026/0184293 A1
(43) Pub. Date: Jul. 2, 2026

(54) ACTUATION DEVICE FOR A BRAKE SYSTEM, AND BRAKE SYSTEM

(71) Applicant: Robert Bosch GmbH, Stuttgart (DE)

(72) Inventors: Bernd Lutz, Kempten (DE); Guenter Escher, Oberstdorf (DE); Mark Boehm, Lehrensteinsfeld (DE); Martin Winkler, Sonthofen (DE)

(21) Appl. No.: 18/868,030

(22) PCT Filed: May 17, 2023
(86) PCT No.: PCT/EP2023/063296

§ 371 Date: Nov. 21, 2024

(30) Foreign Application Priority Data
May 30, 2022 (DE) 10 2022 205 408.3

(51) Int. Cl. B60T 13/74

(52) U.S. Cl. CPC B60T 13/746

(57) ABSTRACT

An actuation device for a brake system. The actuation device includes an electric machine which is arranged in a motor housing, wherein a rotor of the electric machine is arranged on a rotatably mounted drive shaft in a rotationally fixed manner, and including a movably mounted actuator element, wherein the drive shaft is coupled to the actuator element using a transmission device such that the actuator element can be moved by the electric machine, wherein the transmission device has a worm gear including a worm shaft and a worm wheel, and wherein the drive shaft forms the worm shaft. An axis of rotation of the drive shaft is aligned perpendicularly to a movement axis of the actuator element.

### FIELD

The present invention relates to an actuation device for a brake system, comprising an electric machine which is arranged in a motor housing, wherein a rotor of the electric machine is arranged on a rotatably mounted drive shaft in a rotationally fixed manner, and comprising a movably mounted actuator element, wherein the drive shaft is coupled to the actuator element by means of a transmission device such that the actuator element can be moved by the electric machine, wherein the transmission device has a worm gear comprising a worm shaft and a worm wheel, and wherein the drive shaft forms the worm shaft.

The present invention also relates to a brake system.

### BACKGROUND INFORMATION

A hydraulic brake system of a motor vehicle typically has a plurality of friction brake devices. The friction brake devices are operatively connected to an actuation device of the brake system such that the friction brake devices can be actuated by the actuation device. With the increasing electrification of motor vehicles, actuation devices for brake systems are also becoming increasingly electrified. In this respect, it is conventional to equip an actuation device for a brake system with an electric machine which is arranged in a motor housing, wherein a rotor of the electric machine is arranged on a rotatably mounted drive shaft in a rotationally fixed manner. In order to allow the friction brake devices to be actuated by the actuation device, the actuation device also has a movably mounted actuator element. The drive shaft is coupled to the actuator element by means of a transmission device such that the actuator element can be moved by the electric machine. The transmission device is thus designed to convert a rotation of the drive shaft into a translational movement of the actuator element. The friction brake devices can thus be actuated by the electric machine. It is conventional to use a worm gear comprising a worm shaft and a worm wheel in the transmission device. Due to the worm gear, a high transmission ratio can be achieved. Accordingly, due to the worm gear, it is ensured that the noise generated by the actuation device during operation is low. Typically, the worm shaft is formed by the drive shaft. Due to the design as a worm shaft, the drive shaft has a screw thread.

### SUMMARY

An actuation device according to an example embodiment of the present invention may have an advantage that the actuation device can be realized in a cost-effective manner. According to an example embodiment of the present invention, it is provided for this purpose that an axis of rotation of the drive shaft is aligned perpendicularly to a movement axis of the actuator element. Due to the alignment of the axis of rotation of the drive shaft relative to the movement axis of the actuator element in accordance with the present invention, a simple and mechanically robust coupling of the drive shaft to the actuator element in terms of transmission technology can be achieved. Preferably, the worm wheel is arranged coaxially to the actuator element, so that a longitudinal center axis of the worm wheel corresponds to the movement axis of the actuator element. This design of the actuation device has the advantage that the actuation device is compact and thus saves installation space. Preferably, the screw thread of the drive shaft meshes with an external toothing of the worm wheel.

According to a preferred example embodiment of the present invention, it is provided that the transmission device has a spindle gear that is connected downstream of the worm gear in terms of transmission technology. Due to the spindle gear, the conversion of the rotation of the drive shaft into the translational movement of the actuator element can be reliably achieved. In addition, the use of a spindle gear is associated with low production costs. Preferably, the spindle gear has a rotatably mounted spindle nut and a movably mounted threaded spindle. Preferably, the spindle nut forms the worm wheel. Alternatively, the worm wheel is preferably arranged on the spindle nut in a rotationally fixed manner. Preferably, the threaded spindle forms the actuator element. Alternatively, the threaded spindle is preferably coupled to the actuator element such that the actuator element can be moved by the threaded spindle.

According to an alternative example embodiment of the present invention, it is preferably provided that the transmission device has a ball screw drive that is connected downstream of the worm gear in terms of transmission technology. A ball screw drive can also be used to reliably convert the rotation of the drive shaft into the translational movement of the actuator element. Preferably, the ball screw drive has a rotatably mounted nut and a movably mounted threaded spindle, wherein the force transmission between the nut and the threaded spindle is provided by a plurality of balls of the ball screw drive.

According to a preferred example embodiment of the present invention, it is provided that the transmission device is arranged at least partially in a transmission housing of the actuation device, and that the motor housing is fastened to the transmission housing. Due to the arrangement of the transmission device in the transmission housing, the transmission device is protected from external influences by the transmission housing. Preferably, the actuator element is also arranged at least partially in the transmission housing. Due to the fastening of the motor housing to the transmission housing, the actuation device is designed to be mechanically robust overall.

Preferably, the worm gear is arranged in the transmission housing. The drive shaft protrudes out of the motor housing and into the transmission housing such that the screw thread of the drive shaft is arranged in the transmission housing. Preferably, the drive shaft protrudes into the transmission housing through an opening in a housing wall of the transmission housing.

Preferably, the spindle gear or the ball screw drive is arranged at least partially in the transmission housing. In particular, the motor housing is fastened to the transmission housing by at least one fastening means, such as, for example, a screw.

Preferably, the motor housing is fastened to a transmission housing flange of the transmission housing. As a result, a particularly mechanically robust fastening of the motor housing to the transmission housing can be achieved, for example by means of the aforementioned fastening means. In addition, due to the fastening of the motor housing to the transmission housing flange, a fluid seal acting between the motor housing and the transmission housing can also be provided. Preferably, a motor housing flange of the motor housing abuts against the transmission housing flange in a sealing manner for this purpose.

Preferably, the transmission housing is a cylindrical extrusion profile. Extrusion profiles are typically inexpensive to produce, and therefore the production costs for the actuation device are further reduced by designing the transmission housing as an extrusion profile. A cylindrically designed element has a casing wall that is at least substantially closed in the circumferential direction, wherein the casing wall forms or encloses an axial opening in the cylindrical element. Accordingly, the cylindrical extrusion profile also has such a casing wall and such an axial opening, wherein the axial opening forms a housing interior of the extrusion profile. However, the term “cylindrical” does not imply a cross-section with a specific shape. Rather, the cross-section of the extrusion profile can have different shapes. Preferably, however, the axial opening has an at least substantially circular cross-section. Preferably, the extrusion profile is fabricated from aluminum.

According to a preferred example embodiment of the present invention, it is provided that the movement axis of the actuator element is aligned perpendicularly to a cross-sectional area of the extrusion profile. The cross-sectional area of an extrusion profile is the area of which the shape corresponds to the opening of the extrusion tool used to produce the extrusion profile. As mentioned above, the extrusion profile has an axial opening due to its cylindrical design. If the movement axis of the actuator element is aligned perpendicularly to the cross-sectional area of the extrusion profile, the extrusion profile is correspondingly open in the movement direction of the actuator element. As a result, the coupling of the actuator element with a further element such as, for example, a main brake cylinder is simplified.

According to a preferred example embodiment of the present invention, it is provided that at least a first bearing point of the drive shaft is supported by the transmission housing. Because the drive shaft is supported by the transmission housing, the position of the drive shaft in the transmission housing can be defined with particular precision. This means that the introduction of lateral forces into the worm gear can be reduced.

According to a preferred example embodiment of the present invention, the first bearing point is arranged on a side of the screw thread remote from the rotor. Due to the mounting of the drive shaft on the side of the screw thread remote from the rotor, the introduction of transverse forces into the worm gear can be avoided particularly effectively. Preferably, the drive shaft has a second bearing point in addition to the first bearing point, which second bearing point is arranged between the screw thread and the rotor. The second bearing point is preferably supported by a bearing shield arranged on the motor housing. Alternatively, the second bearing point is preferably also supported by the transmission housing. Preferably, in addition to the first bearing point, the drive shaft has a third bearing point, which is arranged on a side of the rotor remote from the screw thread. The third bearing point is particularly preferably supported by a base of the motor housing. Preferably, the drive shaft has both the second and the third bearing point in addition to the first bearing point, so that there are at least three bearing points on the drive shaft in total. Alternatively, the drive shaft has only the second bearing point or only the third bearing point in addition to the first bearing point.

According to a preferred example embodiment of the present invention, it is provided that the drive shaft has a first end on the side of the screw thread remote from the rotor, and that a rotational speed sensor is arranged at the first end. The first end is easily accessible for measuring or detecting the rotational speed of the drive shaft, and therefore the arrangement of the rotational speed sensor at the first end of the drive shaft is preferred. Preferably, the rotational speed sensor is pressed onto the first end. Preferably, the first bearing point is arranged adjacent to the rotational speed sensor. As a result, a particularly precise measurement of the rotational speed of the drive shaft is achieved.

Preferably, the first end protrudes out of the transmission housing. Thus, the drive shaft protrudes through the transmission housing. Because the first end protrudes out of the transmission housing, the accessibility of the first end for rotational speed measurement is further improved.

According to a preferred example embodiment of the present invention, it is provided that the first end protrudes into a control unit of the actuation device. Preferably, the control unit is designed to ascertain the rotational speed of the drive shaft in accordance with a sensor signal from the rotational speed sensor. Because the first end protrudes into the control unit, the signal connection of the rotational speed sensor to the control unit can be technically realized in a simple manner.

A brake system according to an example embodiment of the present invention includes the actuation device according to an example embodiment of the present invention. This also results in the advantages already mentioned. Further preferred features and combinations of features result from what is disclosed herein.

The present invention is explained in more detail below with reference to the figures.

### BRIEF DESCRIPTION OF THE DRAWINGS

FIG. 1 is a sectional view of an actuation device for a brake system, according to an example embodiment of the present invention.

FIG. 2 is a further sectional view of the actuation device, according to an example embodiment of the present invention.

FIG. 3 is a perspective view of a transmission device of the actuation device, according to an example embodiment of the present invention.

FIG. 4 is a sectional view of a spindle gear of the transmission device, according to an example embodiment of the present invention.

### DETAILED DESCRIPTION OF EXAMPLE EMBODIMENTS

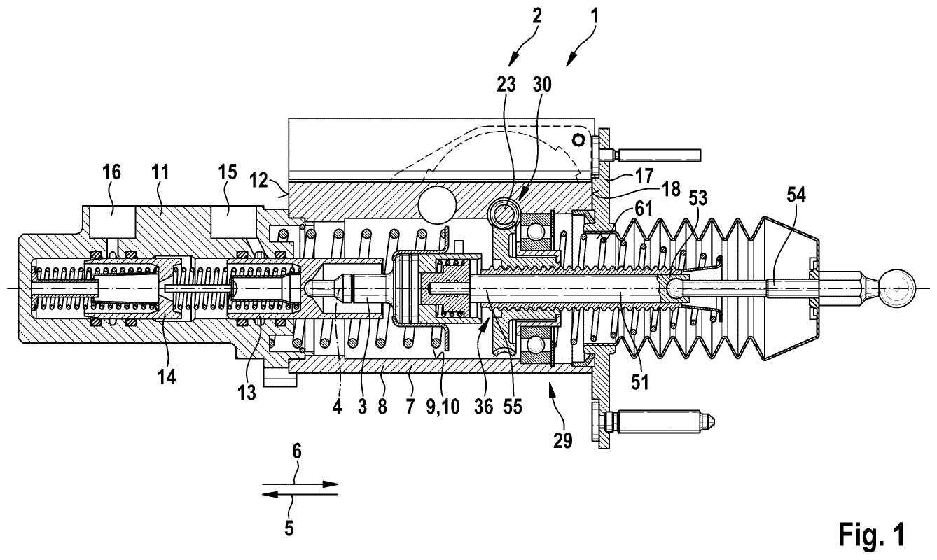

FIG. 1 shows a longitudinal section through an actuation device 1 for a brake system 2, not shown in more detail here, of a motor vehicle. The actuation device 1 has a movably mounted actuator element 3 or push element 3, which in the present case is designed as a push rod 3. The actuator element 3 can be moved along a movement axis 4 in a first direction 5 and in a second direction 6 opposite to the first direction 5. The movement axis 4 corresponds to the longitudinal center axis of the actuator element 3.

The actuator element 3 is arranged at least partially in a transmission housing 7 of the actuation device 1. In the present case, the transmission housing 7 is a cylindrical extrusion profile 7. In this respect, the transmission housing 7 has a casing wall 8 closed in the circumferential direction. The casing wall 8 forms or encloses an axial opening 9 of the transmission housing 7, wherein the axial opening 9 forms a housing interior 10 of the transmission housing 7. In the present case, the axial opening 9 has a circular cross-section. The actuator element 3 is arranged in the transmission housing 7 or the housing interior 10 such that the movement axis 4 is aligned perpendicularly to a cross-sectional area of the transmission housing 7.

A main brake cylinder 11 of the actuation device 1 is arranged in a manner fixed to the transmission housing 7. In the present case, the main brake cylinder 11 is arranged on a first end face 12 of the casing wall 8. A first hydraulic piston 13 and a second hydraulic piston 14 are movably mounted in the main brake cylinder 11, namely so as to move in the first direction 5 and in the second direction 6. The main brake cylinder 11 has a plurality of hydraulic connections 15, 16. If the actuation device 1 is installed in the brake system 2 as intended, the hydraulic connections 15, 16 are fluidically connected to slave cylinders of friction brake devices of the brake system 2. The friction brake devices can then be actuated by moving the hydraulic pistons 13 and 14 in the first direction 5. The actuator element 3 is coupled to the hydraulic pistons 13 and 14 such that the hydraulic pistons 13 and 14 can be moved in the first direction 5 by the actuator element 3. The friction brake devices can thus be actuated by moving the actuator element 3.

A housing plate 17 is also arranged in a manner fixed to the transmission housing 7. In the present case, the housing plate 17 is arranged on a second end face 18 of the casing wall 8 remote from the first end face 12. The housing plate 17 at least partially closes the axial opening 9.

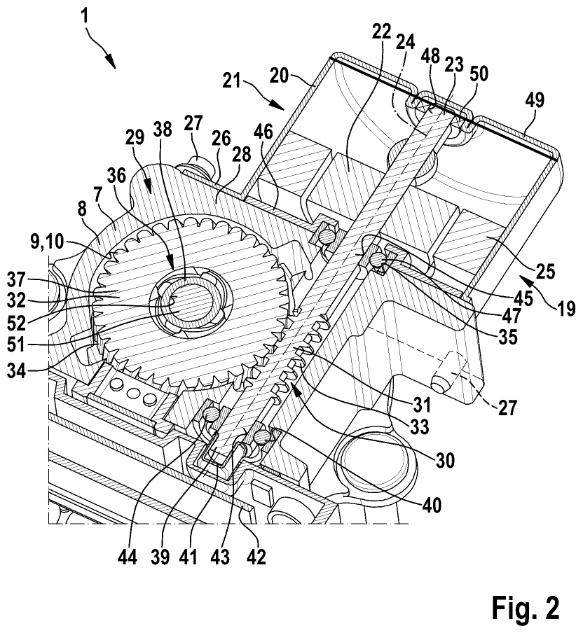

The actuation device 1 also has a drive unit 19. The design of the drive unit 19 is explained in more detail below with reference to FIG. 2. FIG. 2 shows a cross-section through the actuation device 1. The drive unit 19 has a motor housing 20 in which an electric machine 21 is arranged. A ring-shaped rotor 22 of the electric machine 21 is arranged on a drive shaft 23 in a rotationally fixed manner, wherein the drive shaft 23 is mounted so that it can rotate about an axis of rotation 24. A ring-shaped stator 25 of the electric machine 21 is arranged in a manner fixed to the motor housing 20 and encloses the rotor 22 radially in relation to the axis of rotation 24. The motor housing 20 is fastened to the transmission housing 7. In the present case, this is achieved by the fact that a motor housing flange 26 of the motor housing 20 is fastened to a transmission housing flange 28 of the transmission housing 7 by a plurality of fastening means 27.

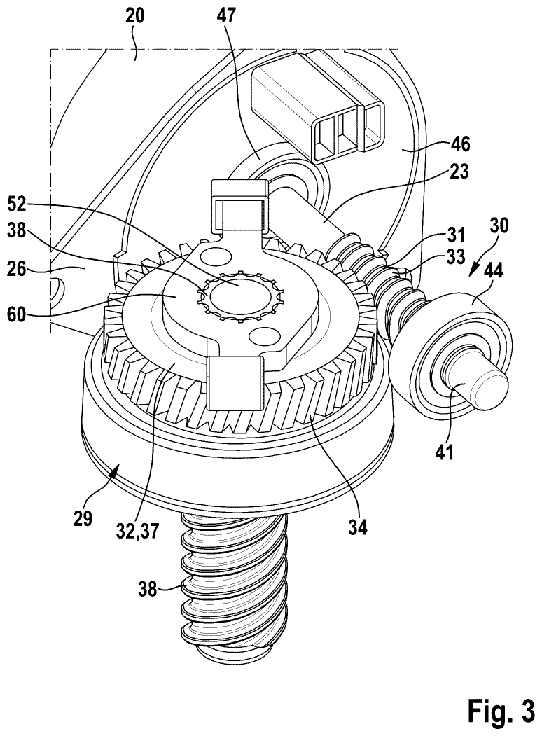

The drive shaft 23 is coupled to the actuator element 3 by means of a transmission device 29 such that the actuator element 3 can be moved by the electric machine 21. FIG. 3 shows a perspective view of the transmission device 29, wherein the transmission housing 7 is omitted in FIG. 3. As can be seen in FIG. 1, for example, the axis of rotation 24 of the drive shaft 23 is aligned perpendicularly to the movement axis 4 of the actuator element 3. As a result, a simple coupling of the drive shaft 23 with the actuator element 3 in terms of transmission technology is made possible.

The transmission device 29 has a worm gear 30. The worm gear 30 has a worm shaft 31 and a worm wheel 32. The worm shaft 31 is formed by the drive shaft 23, wherein the drive shaft 23 has a screw thread 33 for this purpose. The worm wheel 32 has an external toothing 34 that meshes with the screw thread 33. The worm gear 30 is arranged in the transmission housing 7. For this purpose, the drive shaft 23 protrudes out of the motor housing 20 and through a first opening 35 in the casing wall 8 into the transmission housing 7 such that the screw thread 33 is arranged in the transmission housing 7. The worm wheel 32 is arranged coaxially to the actuator element 3 in the housing interior 10. The axis of rotation of the worm wheel 32 thus corresponds to the movement axis 4 of the actuator element 3.

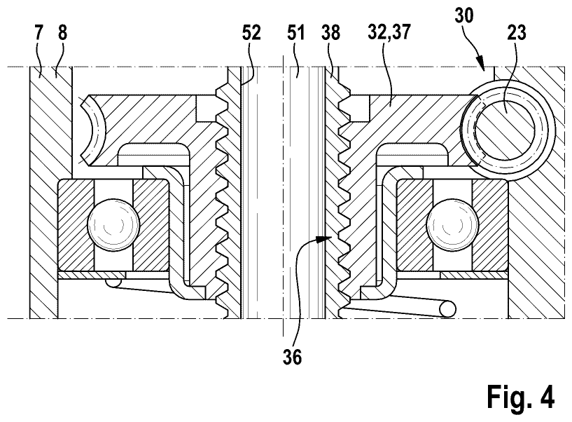

The transmission device 29 also has a further transmission 36, which is designed to convert a rotation into a translational movement. According to the exemplary embodiment shown in the figures, the further gear 36 is designed as a spindle gear 36. FIG. 4 shows a longitudinal section of the actuation device 1 in the region of the spindle gear 36. According to a further exemplary embodiment, the further gear 36 is designed as a ball screw drive, for example.

The spindle gear 36 has a rotatably mounted spindle nut 37 and a movably mounted threaded spindle 38. The spindle gear 36 is also at least partially arranged in the housing interior 10. The spindle nut 37 is arranged coaxially to the worm wheel 32 and can be rotated by the worm gear 30. According to the exemplary embodiment shown in the figures, the spindle nut 37 and the worm wheel 32 are fabricated in one piece. According to a further exemplary embodiment, the worm wheel 32 is arranged on the spindle nut 37 in a rotationally fixed manner, for example. The threaded spindle 38 is coupled to the actuator element 3 such that the actuator element 3 can be moved by the threaded spindle 38 at least in the first direction 5. In the present case, the threaded spindle 38 is arranged in an axial opening 61 in the housing plate 17. An anti-rotation structure 60 is fastened to one end of the threaded spindle 38 facing the actuator element 3. The anti-rotation structure 60 acts together with the transmission housing 7 for supporting the threaded spindle 38.

The drive shaft 23 has a first end 39 on a side of the screw thread 33 remote from the rotor 22. The first end 39 protrudes out of the transmission housing 7 through a second opening 40 in the casing wall 8. A rotational speed sensor 41 is arranged at the first end 39. In the present case, the rotational speed sensor 41 is pressed onto the first end 39. The first end 39 carrying the rotational speed sensor 41 protrudes into a control unit 42 of the actuation device 1. The control unit 42 is designed to ascertain a rotational speed of the drive shaft 23 in accordance with the sensor signal of the rotational speed sensor 41 and to control the electric machine 21 in accordance with the ascertained rotational speed. Because the first end 39 with the rotational speed sensor 41 protrudes into the control unit 42, the sensor signal of the rotational speed sensor 41 can easily be fed to the control unit 42.

The drive shaft 23 has a first bearing point 43. The first bearing point 43 is arranged on the side of the screw thread 33 remote from the rotor 22. In the present case, the bearing point 43 is arranged between the rotational speed sensor 41 and the screw thread 33 adjacent to the rotational speed sensor 41. The first bearing point 43 is supported by the transmission housing 7. In the present case, the transmission housing 7 carries a rotary bearing 44 for this purpose, which rotary bearing acts between the transmission housing 7 and the first bearing point 43 of the drive shaft 23.

The drive shaft 23 also has a second bearing point 45. The second bearing point 45 is arranged between the screw thread 33 and the rotor 22. In the present case, the second bearing point 45 is supported by a bearing shield 46 arranged on the motor housing 20. For this purpose, the end shield 46 carries a rotary bearing 47, which acts between the drive shaft 23, on the one hand, and the end shield 46, on the other hand. According to a further exemplary embodiment, the second bearing point 46 is also supported by the transmission housing 7.

The drive shaft 23 also has a third bearing point 48. The third bearing point 48 is arranged on a side of the rotor 22 remote from the screw thread 33. In the present case, the third bearing point 48 is supported by a base 49 of the motor housing 20. For this purpose, the base 49 carries a rotary bearing 50, which acts between the base 49 and the drive shaft 23.

The actuation device 1 also has an actuation element 51, which is movably mounted in an axial opening 52 of the threaded spindle 38. A first end 53 of the actuation element 51 can be coupled or is coupled to a brake pedal of the brake system 2 by an input rod 54, so that the actuation element 51 can then be moved by actuating the brake pedal. A second end 55 of the actuation element 51 is coupled to the actuator element 3 such that the actuator element 3 can be moved by the actuation element 51. Thus, the friction brake devices can also be actuated by actuating the brake pedal.

1-13. (canceled)

14. An actuation device for a brake system, comprising:
an electric machine which is arranged in a motor housing, wherein a rotor of the electric machine is arranged on a rotatably mounted drive shaft in a rotationally fixed manner; and
a movably mounted actuator element, wherein the drive shaft is coupled to the actuator element via a transmission device such that the actuator element can be moved by the electric machine;
wherein the transmission device has a worm gear including a worm shaft and a worm wheel, and wherein the drive shaft forms the worm shaft; and
wherein an axis of rotation of the drive shaft is aligned perpendicularly to a movement axis of the actuator element.

15. The actuation device according to claim 14, wherein the transmission device has a spindle gear that is connected downstream of the worm gear in terms of transmission technology.

16. The actuation device according to claim 14, wherein the transmission device has a ball screw drive that is connected downstream of the worm gear in terms of transmission technology.

17. The actuation device according to claim 14, wherein the transmission device is arranged at least partially in a transmission housing of the actuation device, and wherein the motor housing is fastened to the transmission housing using at least one fastening element.

18. The actuation device according to claim 17, wherein the motor housing is fastened to a transmission housing flange of the transmission housing.

19. The actuation device according to claim 17, wherein the transmission housing is a cylindrical extrusion profile.

20. The actuation device according to claim 19, wherein the movement axis of the actuator element is aligned perpendicularly to a cross-sectional area of the extrusion profile.

21. The actuation device according to claim 17, wherein at least a first bearing point of the drive shaft is supported by the transmission housing.

22. The actuation device according to claim 21, wherein the drive shaft has a screw thread and the first bearing point is arranged on a side of the screw thread remote from the rotor.

23. The actuation device according to claim 22, wherein the drive shaft has a first end on the side of the screw thread remote from the rotor, and a rotational speed sensor is arranged at the first end.

24. The actuation device according to claim 23, wherein the first end protrudes out of the transmission housing.

25. The actuation device according to claim 23, wherein the first end protrudes into a control unit of the actuation device.

26. A brake system, comprising:
an actuation device including:
an electric machine which is arranged in a motor housing, wherein a rotor of the electric machine is arranged on a rotatably mounted drive shaft in a rotationally fixed manner, and
a movably mounted actuator element, wherein the drive shaft is coupled to the actuator element via a transmission device such that the actuator element can be moved by the electric machine,
wherein the transmission device has a worm gear including a worm shaft and a worm wheel, and wherein the drive shaft forms the worm shaft, and
wherein an axis of rotation of the drive shaft is aligned perpendicularly to a movement axis of the actuator element.
